(19) United States
(12) Patent Application Publication
(10) Pub. No.: US 2013/0270912 A1
(43) Pub. Date: Oct. 17, 2013

(54) SYSTEM AND METHOD FOR PROVIDING TIME-CONTROLLED BACKUP POWER TO A LOAD

(71) Applicant: Michael Krenz, Roscoe, IL (US)

(72) Inventor: Michael Krenz, Roscoe, IL (US)

(73) Assignee: HAMILTON SUNDSTRAND CORPORATION, Windsor Locks, CT (US)

(21) Appl. No.: 13/447,582

(22) Filed: Apr. 16, 2012

(51) Int. Cl. H02J 9/06

(52) U.S. Cl. 307/66

(57) ABSTRACT

A power distribution system and method includes one or more primary power sources for supplying power to a load, and an uninterruptible power source for supplying power to the load during a power interrupt. The power distribution system and method also includes a controller for connecting the uninterruptible power source to the load for up to a first predetermined time period when the one or more primary power sources are unavailable, and disconnecting the load from the uninterruptible power source following the first predetermined time period until power has been provided to the load from the one or more primary power sources for a second predetermined time period.

### BACKGROUND

The present invention relates to power distribution, and in particular to a system and method for providing time-controlled backup power to a load.

An aircraft generates and consumes its own power. Any interruptions in the distribution of power can cause a load to reset, flicker, or have other undesirable effects. Thus, some systems onboard the aircraft have implemented internal hold-up power supplies in order to provide local backup power to prevent a reset of the system upon a loss of primary power. This has been accomplished by incorporating an internal backup battery in each local system, or by providing energy storage in the form of capacitors. Batteries require extra maintenance because they need to be tested and replaced on a regular basis. To get around this, local capacitors have also been used. These capacitors store energy locally, and provide this energy during a power interrupt. This creates added complexity, volume, cost and weight to the internal systems.

Aircraft also include a backup power supply for providing power to essential systems such as flight control if primary power from the engines is lost. This is often a large battery that is only used for critical systems in emergencies. These batteries have a limited capacity of, for example, 30 minutes of use without being recharged. Therefore, the batteries have traditionally only been used to provide extended power to the essential systems of the aircraft during a loss of primary power.

### SUMMARY

A power distribution system and method includes one or more primary power sources, an uninterruptible power source, and a controller. The one or more primary power sources supply power to a load. When the one or more primary power sources are unavailable, the controller connects the uninterruptible power source to the load for up to a first predetermined time period. Following the first predetermined time period, the controller disconnects the uninterruptible power source from the load until power has been provided to the load from the one or more primary power sources for a second predetermined time period.

### BRIEF DESCRIPTION OF THE DRAWINGS

FIG. 1 is a block diagram illustrating a system according to an embodiment of the present invention.

FIG. 2 is a flowchart illustrating a method of providing time limited backup power to a load during a power interrupt.

### DETAILED DESCRIPTION

The present invention describes a system and method for providing time-controlled backup power to a load. Because an aircraft generates and consumes its own power, if a load loses power mid-flight, it will reset. When primary power is lost, flight-critical loads receive power from an uninterruptible power source in order to keep them running for as long as possible. This uninterruptible power source can also be utilized to provide other, non-flight-critical loads of an aircraft a limited amount of backup power in order to prevent resets during short power interrupts. When a power interrupt occurs, these loads will receive power from the uninterruptible power source until either primary power is restored, or uninterruptible power has been supplied to the load for a set time period. If primary power has not been restored following the set time period, the load will lose power and reset. This ensures that these loads do not create an unwanted drain on the uninterruptible power source. Following receipt of power from the uninterruptible power source, the loads can no longer receive uninterruptible power until primary power has been restored for set amount of time. This ensures that primary power is not pulsing, which would allow the non-flight critical loads to repeatedly pull power from, and therefore drain, the uninterruptible power source.

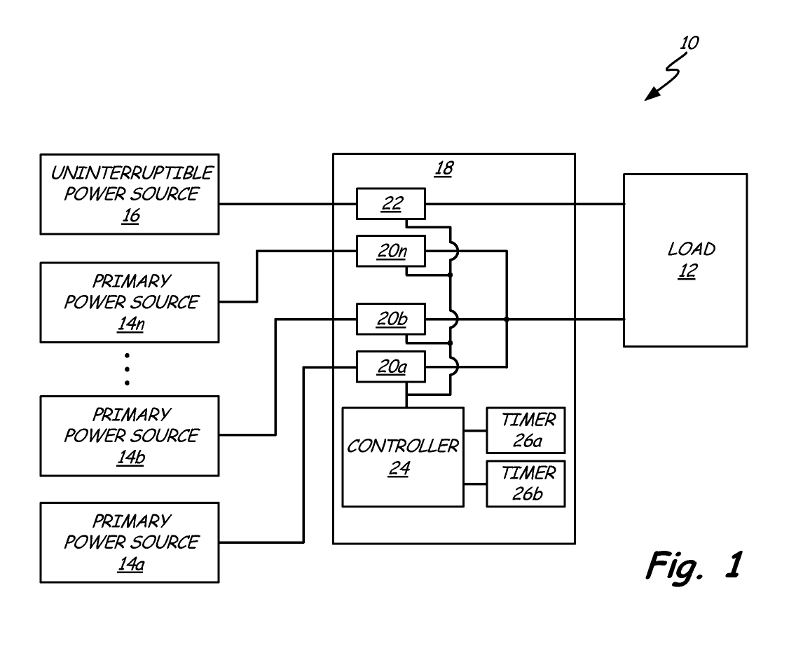

FIG. 1 is a block diagram illustrating a system 10 according to an embodiment of the present invention. System 10 includes load 12, primary power sources 14a-14n, uninterruptible power source 16, assembly 18, primary power switches 20a-20n, uninterruptible power switch 22, controller 24, and timers 26a-26b. Timers 26a-26b may be implemented onboard assembly 18, for example, as analog or digital timers. Controller 24 is, for example, a microcontroller such as a field programmable gate array (FPGA) implemented on assembly 18 to control primary power switches 20a-20n, uninterruptible power switch 22, and to monitor for power interrupts. Primary power switches 20a-20n and uninterruptible power switch 22 may be implemented using, for example, power metal-oxide-semiconductor field-effect transistors (MOSFETs).

During normal system operation, load 12 receives power from one of primary power sources 14a-14n. Primary power sources 14a-14n are any sources of primary power, such as electrical generators driven by the main engines of an aircraft. Controller 24 may control primary power switches 20a-20n to provide power from any of primary power sources 14a-14n using, for example, digital logic. Additionally, diode OR'ing may be used to select the primary power source 14a-14n that is used to supply power to load 12. With diode OR'ing, the supply 14a-14n that is supplying the greatest electric potential will forward bias its corresponding diode and provide power to load 12.

Uninterruptible power source 16 is implemented to provide time-limited backup power to load 12. Uninterruptible power source 16 is any power source capable of energy storage, such as a fuel cell or a battery. When an interrupt in power from primary power sources 14a-14n occurs, power is provided to load 12 from uninterruptible power source 16. Given the fast switching capabilities of power MOSFETs, the same command from controller 24 that opens primary power switches 20a-20n may be used to close uninterruptible power switch 22, creating no break in the power provided to load 12. Diode OR'ing may also be utilized such that during a power interrupt, a diode associated with uninterruptible power source 16 becomes forward biased, providing power to the load. In the case of diode OR'ing, it would need to be assured that during normal system operation, primary power supplies 14a-14n are providing a greater electric potential than uninterruptible power source 16.

Uninterruptible power can only be provided to load 12 for a limited time period so as not to drain uninterruptible power source 16. Power from uninterruptible power source 16 is generally used to provide extended backup power to flight critical systems onboard the aircraft. Because of this, the limited time period must be set to provide the maximum amount of interrupt protection to all loads without draining uninterruptible power source 16 for later emergency use. This limited time is application specific and can range from a few hundred milliseconds to several seconds. Timer 26a is implemented to keep track of this limited time period. System 10 is designed such that load 12 may receive backup power from uninterruptible power source 16 if timer 26a is set to its initial state. If timer 26a is set to its initial state when a power interrupt occurs, controller 24 starts timer 26a and closes uninterruptible power switch 22 to provide backup power to load 12. Power interrupts may be detected by controller 24, for example, by monitoring a voltage or current from primary power sources 14a-14n. When either primary power has been restored from primary power sources 14a-14n, or timer 26a reaches a value indicative of the maximum allowable backup power time, controller 24 opens uninterruptible power switch 22 to cut off backup power to load 12.

Following termination of backup power, controller 24 denies power from uninterruptible power source 16 to load 12 until primary power has been restored to load 12 for a predetermined time period. This time period is application specific and is set to a time that ensures primary power sources 14a-14n are not pulsing and that uninterruptible power source 16 has adequate time to recharge. For instance, one of primary power sources 14a-14n may continuously spike, causing timer 26a to reset every time a spike occurs. Without waiting for primary power to be restored continuously for a predetermined time, load 12 would pull from uninterruptible power source 16 every time a spike occurs. If the spikes happen frequently, a significant drain on uninterruptible source 16 could be created.

Controller 24 starts timer 26b when power has been restored to load 12 from primary power sources 14a-14n following a power interrupt. Power may be restored by controller 24 detecting that one of primary power sources 14a-14n is functioning properly and closing the respective primary power switch 20a-20n. If power is lost from primary power sources 14a-14n prior to timer 26b reaching a value indicative of the second predetermined time, timer 26b is reset by controller 24 and will be started upon power once again being restored from primary power sources 14a-14n. If timer 26b reaches the predetermined time period while primary power is still being provided to load 12, timer 26a is reset to its initial state, allowing load 12 to once again receive power from uninterruptible power source 16 upon a power interrupt.

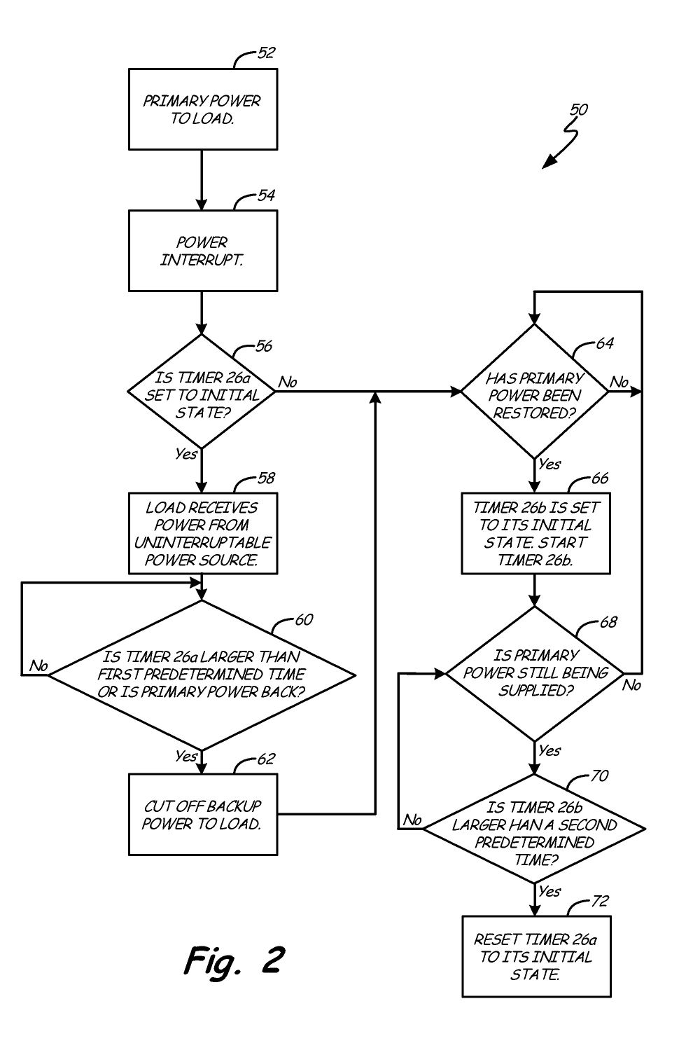

FIG. 2 is a flowchart illustrating method 50 of providing time-controlled backup power to a load during a power interrupt. At step 52, power is provided to load 12 from one of primary power sources 14a-14n. At step 54, a power interrupt occurs. At step 56, it is determined if timer 26a is set to its initial state. If timer 26a is not set to its initial state, method 50 proceeds to step 64. At step 58, load 12 begins receiving power from uninterruptible power source 16. Method 50 remains at step 60 until either timer 26a reaches a value indicative of a first predetermined time, or primary power is restored to load 12. At step 62, controller 24 cuts off backup power from uninterruptible power source 16 to load 12. Method 50 remains at step 64 until primary power has been restored. At step 66, timer 26b is set to its initial state and begins counting. At step 68, it is determined if primary power is still being supplied to load 12. If it is, method 50 proceeds to step 70. If it is not, method 50 returns to step 64. At step 70, it is determined if timer 26a has reached a value indicative of a second predetermined time period. If it has, method 50 proceeds to step 72. If it has not, method 50 returns to step 68. At step 72, timer 26a is reset to its initial state so that load 12 may once again receive backup power from uninterruptible power source 16 upon a power interrupt.

In this way, the present invention describes a system and method for providing time-controlled backup power to a load. Although the present invention has been described with reference to preferred embodiments, workers skilled in the art will recognize that changes may be made in form and detail without departing from the spirit and scope of the invention.

1. A power distribution system comprising:
one or more primary power sources for supplying power to a load;
an uninterruptible power source for supplying power to the load during a power interrupt; and
a controller for connecting the uninterruptible power source to the load for up to a first predetermined time period when the one or more primary power sources are unavailable, and disconnecting the load from the uninterruptible power source following the first predetermined time period until power has been provided to the load from the one or more primary power sources for a second predetermined time period.

2. The system of claim 1, further comprising:
one or more primary power switches for connecting the one or more primary power sources to provide power to the load; and
an uninterruptible power switch for connecting the uninterruptible power source to provide power to the load.

3. The system of claim 2, wherein the one or more primary switches, the uninterruptible power switch, and the controller are located on an assembly.

4. The system of claim 3, wherein the controller controls the one or more primary power switches and the uninterruptible power switch.

5. The system of claim 4, wherein the controller further comprises:
a first timer for timing the first predetermined time period that begins when the uninterruptible power switch is closed; and
a second timer for timing the second predetermined time period that begins when primary power is restored to the load following the power interrupt.

6. The system of claim 1, wherein the uninterruptible power source is a battery.

7. A power distribution method comprising:
supplying power to a load from one or more primary power sources;
supplying power to the load from an uninterruptible power source using a controller for up to a first time period following an interrupt of power of the one or more primary power sources; and
denying power to the load from the uninterruptible power source using the controller until the load has been supplied power from the one or more primary power sources continuously for a second time period.

8. The method of claim 7, wherein supplying power to the load from the one or more primary power sources comprises closing one or more primary power switches associated with the one or more primary power sources.

9. The method of claim 8, wherein supplying power to the load from the uninterruptible power source for up to a first time period comprises:
closing an uninterruptible power switch to provide power from the uninterruptible power source to the load;
starting a first timer; and
opening the uninterruptible power switch upon the first timer indicating the first time period has passed or detecting that primary power has been restored.

10. The method of claim 9, wherein denying power to the load from the uninterruptible power source until the load has been supplied power from the one or more primary power sources continuously for a second time period comprises:
a. closing the one or more primary power switches associated with the one or more primary power sources to provide power to the load upon primary power becoming available;
b. starting a second timer;
c. resetting the second timer and returning to step a if power is lost from the one or more primary power sources; and
d. resetting the first timer after the second timer indicates the second time period has passed.

11. A power distribution control method comprising:
operating a primary power switch to provide primary power to a load;
determining that a power interrupt has occurred;
operating a backup power switch to provide power from a backup power source to the load for up to a first time period; and
operating the backup power switch to deny power from the backup power source to the load until primary power has been supplied to the load continuously for a second time period.

12. The method of claim 11, wherein operating the backup power switch to provide power from the backup power source to the load for up to the first time period comprises:
closing the backup power switch to provide power from the backup power source to the load;
starting a first timer; and
opening the backup power switch upon the first timer indicating the first time period has passed or determining that primary power has been restored.

13. The method of claim 12, wherein operating the backup power switch to deny power from the backup power source to the load until primary power has been supplied to the load continuously for a second time period comprises:
a. determining that primary power has been restored;
b. closing the primary power switch to provide power to the load;
c. starting a second timer;
d. returning to step a and resetting the second timer if primary power is interrupted; and
e. resetting the first timer if the second timer indicates the second time period has passed.

14. The method of claim 13, wherein operating the primary power switch and operating the backup power switch is accomplished using a controller.

15. The method of claim 14, wherein the primary power switch, the backup power switch, and the controller are located on an assembly.

16. The method of claim 13, wherein the first and second timers are operated using a controller.
